(19) United States
(12) Patent Application Publication
(10) Pub. No.: US 2003/0157958 A1
(43) Pub. Date: Aug. 21, 2003

(54) Personal communication systems

(76) Inventor: Claire E. Bamber, Cincinnati, OH (US)

Correspondence Address: Jeffrey V. Bamber, 5023 Village Drive, Cincinnati, OH, 45244, US

(21) Appl. No.: 10/368,905

(22) Filed: Feb. 18, 2003

Related U.S. Application Data
(60) Provisional application No. 60/358,039, filed on Feb. 19, 2002.

(51) Int. Cl. H04B 1/38

(52) U.S. Cl. 455/550; 455/575; 455/90

(57) ABSTRACT

Personal communication systems, and more particularly personal communication systems that can be worn are disclosed. In one non-limiting embodiment, the personal communication system comprises a device having a microphone that is located on the user's hand, such as on one of the user's fingers and an ear piece that is located on another portion of the user's hand, such as on another one of the wearer's fingers.

### CROSS-REFERENCE TO RELATED APPLICATIONS

This application claims the benefit of the filing date of U.S. Provisional patent application, Serial No. 60/358,039, filed on Feb. 19, 2002, which is incorporated by reference herein.

### FIELD OF THE INVENTION

The present invention relates to personal communication systems, and more particularly to personal communication systems that can be worn.

### BACKGROUND OF THE INVENTION

There is an increasing need for personal communication systems, such as cellular phones, and the like, that can be more conveniently be carried and used. Oftentimes, cellular phones cannot be conveniently carried by a person in their pockets, purses or the like. This may be due to the size of the phone, or the difficulty of removing the cellular phone from their pocket, purses or the like. This is especially true when a person is driving in a vehicle and has their seat belt fastened. Similar difficulties arise when the person attempts to hold their cellular phone when driving a car or other vehicle.

U.S. Pat. 6,212,414 B1 issued to Alameh, et al., assigned to Motorola, Inc., is directed to a wrist-carried radiotelephone. The wrist-carried radiotelephone described in this patent has a microphone located in the wristband or housing of the radiotelephone, or in a headset. The ear piece of the radiotelephone can be at the end of a retractable tether. The ear piece can be configured to fit at the base between two of the user's fingers near the user's palm. Alternatively, the ear piece can be a ring to be worn on the user's finger and held in proximity to the user's ear. In the embodiments disclosed in this patent, the microphone and the ear piece are not as conveniently located as they could be so that the microphone is located near the user's mouth and the ear piece is located near the user's ear.

Thus, there is a need to provide personal communication systems, such as cellular phones, and the like, that can be more conveniently be carried and used.

### SUMMARY OF THE INVENTION

The present invention relates to personal communication systems, and more particularly to personal communication systems that can be worn.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention.

In one non-limiting embodiment, the personal communication system comprises a device such as a cellular telephone having a microphone that is located on the user's hand, such as on one of the user's fingers and an ear piece that is either located on another portion of the user's hand, such as on another one of the wearer's fingers (including the user's thumbs), or is located within or adjacent to the user's ear.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is a perspective view of one non-limiting embodiment of a personal communication system showing one way in which a user of the personal communication system might hold their hand when using the personal communication system.

### DETAILED DESCRIPTION OF THE INVENTION

The present invention relates to personal communication systems, and more particularly to personal communications systems that can be worn. The term “personal communication systems”, as used herein, is intended to refer to communication systems for use by individuals and includes those used for personal and business purposes.

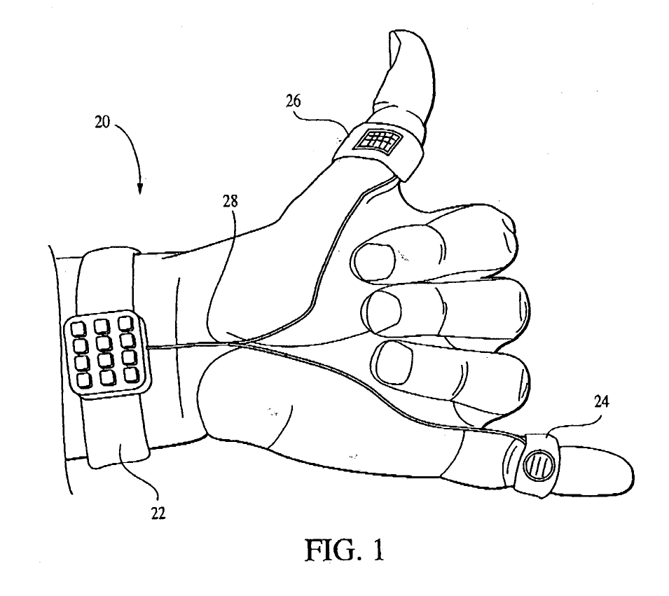

One non-limiting embodiment of the personal communication system is shown in FIG. 1. The personal communication system 20 shown in FIG. 1 can be a pager, a cellular telephone, a cordless telephone, or a personal communication service (PCS) radiotelephone, or any other type of device by which the user may communicate to another person or device (such devices include, but are not limited to computers).

In the embodiment shown in FIG. 1, the personal communication system 20 comprises a device such as a cellular telephone that has components located in a wrist unit 22 and a microphone 24 that is located on one of the user's fingers and an ear piece 26 that is located on another one of the wearer's fingers (including the user's thumbs).

The wrist unit 22 may, if desired, be in the configuration of a bracelet, wristwatch, or some other configuration. The wrist unit 22 may comprise a housing that contains some or all of the telephone circuitry. The housing can be located on any portion of the wrist unit 22. The housing can be located on a band, and can be located on the portion of the wearer's wrist that corresponds to the back of the user's hand, in the same manner that most watches are worn. In other embodiments, it can be located on the inside portion of the wearer's wrist as shown in FIG. 1, or on any other suitable location. In addition, instead of all the telephone circuitry residing in a housing, some or all of the telephone circuitry may reside in all or a portion of the band on the user's wrist.

The microphone 24 can be located on one of the wearer's fingers, such as on a ring worn on the user's fingers. In the non-limiting embodiment shown, the microphone is worn on the user's pinkie finger. The ear piece 26 can be located on one of the wearer's other fingers, such as in the form of a ring worn on the wearer's thumb.

The personal communication system can be any type of device described in U.S. Pat. No. 6,212,414 B1 issued to Alameh, et al., and can have any of the components and features of the devices described therein. For example, the personal communication system may have a keypad, or it can use voice recognition software instead of, or in addition to a keypad.

The main components of the personal communication system 20 (such as the wrist unit 22, microphone 24, and ear piece 26) can be connected by wires 28, by wireless connections (e.g., wireless infared or radio frequency), or they can be independent units capable of operating together. If wires are used, the wires 28 can, if desired, be retractable. If retractable wires are used, they can retract into the wrist unit, into the microphone 24, into the ear piece 26, or both. If retractable wires are used, they can either be detached (for example, unplugged) from the microphone 24 and ear piece 26, or they can remain attached to at least one of these components. If the retractable wires retract into the wrist unit, and remain attached to the same, the wrist unit can have a configuration (for example, a recess) or component (for example a clip, etc.) that serves as a holder for the microphone 24 and/or the ear piece 26. In addition, or alternatively, the wires can be decoratively configured (such as in the form of gold or silver chains, etc.).

The components of the personal communication system 20 can be assembled in any suitable manner, including the manner described in any of the patents incorporated by reference herein.

The personal communication system 20 can be used in a manner similar to a conventional cellular telephone, except that in the case of the embodiment shown in the drawings, the user will hold their hand adjacent to their head, with their thumb with the ear piece 26 thereon near their ear for listening, and their pinkie finger with the microphone 24 thereon near their mouth for speaking.

Numerous other arrangements are possible. In another embodiment, for example, the user can wear the microphone 24 on their thumb, possibly more toward the end of the same, and the ear piece 26 on their index finger, and can hold their thumb and index finger in an “L” configuration with their thumb by their mouth and the end of their index finger by their ear. In still other embodiments, the ear piece 26 can be in the form of an “ear bud” that the user places in their ear. Such an ear bud could be connected by wires to one or more of the other components, or it can be wireless.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined solely by the appended claims which should be construed as broadly as the prior art will permit.

What is claimed is:

1. A personal communication system comprising the following components:
a wrist unit for wearing on a user's wrist;
a microphone that is located on a portion of the user's hand; and
an ear piece that is located on another portion of the user's hand, wherein said wrist unit, microphone, and ear piece are in a relationship where there is communication with at least one of the other components of the system during use of the system.

2. The personal communication system of claim 1 wherein the microphone is located on one of the user's fingers including the user's thumb, and the ear piece is located on another one of the user's fingers including the user's thumb.

3. The personal communication system of claim 2 wherein the microphone is located on the user's pinkie finger and the ear piece is located on the user's thumb.

4. The personal communication system of claim 1 wherein at least some of said components are in communication via wires.

5. The personal communication system of claim 1 wherein at least some of said components are in wireless communication.
